(19) United States
(12) Patent Application Publication
(10) Pub. No.: US 2025/0139635 A1
(43) Pub. Date: May 1, 2025

(54) SYSTEMS AND METHODS FOR LIMITING DATA TRANSFERS ACROSS MULTIPLE PLATFORMS

(71) Applicant: The Toronto-Dominion Bank, Toronto (CA)

(72) Inventors: Laird Jerome HERCULES, Barrie (CA); Anisa Abdulkadir Ibrahim ULUSOW, Toronto (CA)

(73) Assignee: The Toronto-Dominion Bank, Toronto (CA)

(21) Appl. No.: 18/499,468

(22) Filed: Nov. 1, 2023

(51) Int. Cl. G06Q 20/40; G06Q 20/10

(52) U.S. Cl. CPC G06Q 20/405; G06Q 20/10

(57) ABSTRACT

Systems and methods for performing an operation intending to limit further in-application transfers are provided. A system may determine that a first transfer associated with a first account represents a first in-application transfer associated with a first application of a first type. The system may then calculate a sum of one or more transfer amounts associated with one or more in-application transfers during a time period. The system may then determine, based on a threshold defined for the time period, that the sum satisfies defined criteria. The system may then perform an operation intending to limit further in-application transfers associated with the first account during the time period.

### TECHNICAL FIELD

The present disclosure relates to data transfers, and to systems and methods for monitoring and managing data transfer limits.

### BACKGROUND

Data transfer limits can be challenging to monitor, especially when the transfers may be initiated from multiple remote devices. For example, multiple users may be authorized to initiate data transfers from a first location. Each of the multiple users may be remote to one another and may be operating differing computing devices. The computing devices may each comprise different hardware, different operating systems, different software applications, etc., and may lack interoperability.

As a result, a first user preparing to initiate a data transfer from the first location may be unaware that a second user has recently initiated a data transfer from the first location. In the absence of a means for communicating appropriate dynamic transfer limit information among multiple different computing devices, a corresponding data transfer limit can be difficult to manage.

Improvements to the field are desired.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is high-level schematic diagram of a computing device;

FIG. 3 shows a simplified organization of software components stored in a memory of the computing device of FIG. 2;

FIG. 4 is a flowchart illustrating a method for performing an operation intending to limit further in-application transactions, in accordance with embodiments of the present disclosure;

FIG. 5 is a flowchart illustrating a method for transmitting an instruction configured to cause a generation of a first notification, in accordance with embodiments of the present disclosure;

FIG. 6 shows the front of a first example gaming device of FIG. 1, in accordance with embodiments of the present disclosure;

FIG. 7 shows the front of a second example gaming device of FIG. 1 in accordance with embodiments of the present disclosure; and

FIG. 8 illustrates an example user interface, in accordance with embodiments of the present disclosure.

Like reference numerals are used in the drawings to denote like elements and features.

### DETAILED DESCRIPTION OF VARIOUS EMBODIMENTS

In accordance with one aspect of the present disclosure, there is provided a computer system comprising a processor, a communications module coupled to the processor, and a memory coupled to the processor. The memory stores instructions that, when executed by the processor, cause the computer system to: determine, based on a first transfer identifier associated with a first transfer having a first transfer amount, that the first transfer represents a first in-application transfer associated with a first application of a first type, the first transfer being associated with a first account; calculate a sum of one or more transfer amounts associated with one or more in-application transfers during a time period, the one or more in-application transfers being associated with the first account and including the first transfer, the one or more in-application transfers being associated with one or more applications of the first type; determine, based on a threshold defined for the time period, that the sum satisfies defined criteria; and in response to determining that the sum satisfies the defined criteria, perform an operation intending to limit further in-application transfers associated with the first account during the time period, the in-application transfers being associated with the one or more applications of the first type.

In some implementations, performing the operation causes the computer system to: identify a first user computing device associated with the first application; establish, via the communications module and through a first application programming interface (API) associated with the first user computing device, a communications connection with the first user computing device; and transmit, via the communications module, an instruction configured to cause a generation, by the first user computing device, of a first notification.

In some implementations, performing the operation causes the computer system to restrict, for a remainder of the time period, approval of subsequent transfer requests in connection with an in-application transfer associated with an application of a first type, wherein the subsequent transfer requests are associated with the first account.

In some implementations, the one or more in-application transfers are further associated with a first transfer card associated with the first account.

In some implementations, prior to calculating the sum, the computer system is further caused to determine, based on a second transfer identifier associated with a second transfer having a second transfer amount, that the second transfer represents a second in-application transfer in connection with a second application of the first type, the second transfer being associated with the first account. The one or more transfer amounts may further include the second transfer amount.

In some implementations, performing the operation causes the computer system to: identify a first user computing device associated with the first application; establish, via the communications module and through a first API associated with the first user computing device, a communications connection with the first user computing device; transmit, via the communications module, an instruction configured to cause a generation, by the first user computing device, of a first notification; identify a second user computing device associated with the second application; establish, via the communications module and through a second API associated with the second user computing device, a communications connection with the second user computing device; and transmit, via the communications module, an instruction configured to cause a generation, by the second user computing device, of a second notification.

In some implementations, prior to performing the operation intended to limit further in-application transfers, the computer system is further caused to determine that a third transfer represents a third in-application transfer associated with a third application of the first type, the third transfer being associated with the first account and occurring outside of the time period. Performing the operation may cause the computer system to: identify a third user computing device associated with the third application; establish, via the communications module and through a third API associated with the third user computing device, a communications connection with the third user computing device; and transmit, via the communications module, an instruction configured to cause a generation, by the third user computing device, of a third notification.

In some implementations, performing the operation further causes the computer system to provide user interface data to a fourth user computing device associated with the first account, the user interface data causing the fourth user computing device to display a user interface including a fourth notification.

In some implementations, the first transfer is associated with a first transfer card associated with the first account, and the second transfer is associated with a second transfer card associated with the first account.

In some implementations, the threshold is a defined amount and wherein the defined criteria are satisfied when the calculated sum exceeds a certain percentage of the defined amount.

In accordance with another aspect of the present disclosure, there is provided a computer-implemented method. The computer-implemented method comprises: determining, based on a first transfer identifier associated with a first transfer having a first transfer amount, that the first transfer represents a first in-application transfer associated with a first application of a first type, the first transfer being associated with a first account; calculating a sum of one or more transfer amounts associated with one or more in-application transfers during a time period, the one or more in-application transfers being associated with the first account and including the first transfer, the one or more in-application transfers being associated with one or more applications of the first type; determining, based on a threshold defined for the time period, that the sum satisfies defined criteria; and in response to determining that the sum satisfies the defined criteria, performing an operation intending to limit further in-application transfers associated with the first account during the time period, the in-application transfers being associated with the one or more applications of the first type.

In some implementations, performing the operation comprises: identifying a first user computing device associated with the first application; establishing, via a communications module and through a first application programming interface (API) associated with the first user computing device, a communications connection with the first user computing device; and transmitting, via the communications module, an instruction configured to cause a generation, by the first user computing device, of a first notification.

In some implementations, performing the operation comprises restricting, for a remainder of the time period, approval of subsequent transfer requests in connection with an in-application transfer associated with an application of a first type. The subsequent transfer requests may be associated with the first account.

In some implementations, the one or more in-application transfers are further associated with a first transfer card associated with the first account.

In some implementations, prior to calculating the sum, the method further comprises determining, based on a second transfer identifier associated with a second transfer having a second transfer amount, that the second transfer represents a second in-application transfer in connection with a second application of the first type, the second transfer being associated with the first account. The one or more transfer amounts may further include the second transfer amount.

In some implementations, performing the operation comprises: identifying a first user computing device associated with the first application; establishing, via a communications module and through a first API associated with the first user computing device, a communications connection with the first user computing device; transmitting, via the communications module, an instruction configured to cause a generation, by the first user computing device, of a first notification; identifying a second user computing device associated with the second application; establishing, via the communications module and through a second API associated with the second user computing device, a communications connection with the second user computing device; and transmitting, via the communications module, an instruction configured to cause a generation, by the second user computing device, of a second notification.

In some implementations, prior to performing the operation intended to limit further in-application transfers, the method further comprises determining that a third transfer represents a third in-application transfer associated with a third application of the first type, the third transfer being associated with the first account and occurring outside of the time period. Performing the operation may comprise: identifying a third user computing device associated with the third application; establishing, via a communications module and through a third API associated with the third user computing device, a communications connection with the third user computing device; and transmitting, via the communications module, an instruction configured to cause a generation, by the third user computing device, of a third notification.

In some implementations, performing the operation further comprises providing user interface data to a fourth user computing device associated with the first account, the user interface data causing the fourth user computing device to display a user interface including a fourth notification.

In some implementations, the first transfer is associated with a first transfer card associated with the first account, and the second transfer is associated with a second transfer card associated with the first account.

In accordance with yet another aspect of the present disclosure, there is provided a non-transitory computer-readable storage medium comprising processor-executable instructions. The instructions, when executed, configure a processor to: determine, based on a first transfer identifier associated with a first transfer having a first transfer amount, that the first transfer represents a first in-application transfer associated with a first application of a first type, the first transfer being associated with a first account; calculate a sum of one or more transfer amounts associated with one or more in-application transfers during a time period, the one or more in-application transfers being associated with the first account and including the first transfer amount, the one or more in-application transfers being associated with one or more applications of the first type; determine, based on a threshold defined for the time period, that the sum satisfies defined criteria; and in response to determining that the sum satisfies the defined criteria, perform an operation intending to limit further in-application transfers associated with the first account during the time period, the in-application transfers being associated with the one or more applications of the first type.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Example embodiments of the present application are not limited to any particular operating system, system architecture, mobile device architecture, server architecture, or computer programming language.

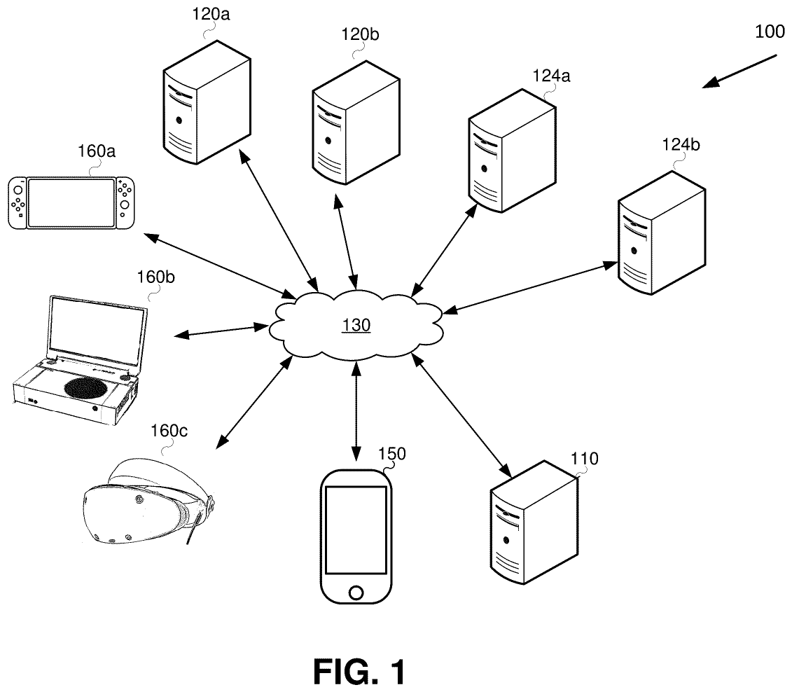

FIG. 1 is a schematic operation diagram illustrating an exemplary operating environment 100, in accordance with embodiments of the present disclosure.

As illustrated, a resource management system 110, a client device 150, transfer initiation systems 124a, 124b, transfer rail servers 120a, 120b, and first, second, and third gaming devices 160a, 160b, 160c, communicate via a network 130. Gaming devices 160a, 160b, 160c, and client device 150 are user computing devices.

The resource management system 110, the client device 150, the transfer initiation systems 124a, 124b, the transfer rail servers 120a, 120b, and the gaming devices 160a, 160b, 160c are computer systems. Computer systems may be, for example, a mainframe computer, a minicomputer, or the like. Computer systems may include one or more computing devices. For example, a computer system may include multiple computing devices such as, for example, database servers, computer servers, and the like. The multiple computing devices may be in communication using a computer network. For example, computing devices may communicate using a local-area network (LAN). In some embodiments, computer systems may include multiple computing devices organized in a tiered arrangement. For example, a computer system may include middle-tier and back-end computing devices. In some embodiments, a computer system may be a cluster formed of a plurality of interoperating computing devices.

Each of the resource management system 110, the client device 150, the transfer initiation systems 124a, 124b, the transfer rail servers 120a, 120b, and the gaming devices 160a, 160b, 160c, may be in geographically disparate locations. Put differently, one or more of the resource management system 110, the client device 150, the transfer initiation systems 124a, 124b, the transfer rail servers 120a, 120b, and the gaming devices 160a, 160b, 160c, may be remote to others of the resource management system 110, the client device 150, the transfer initiation systems 124a, 124b, the transfer rail servers 120a, 120b, and the gaming devices 160a, 160b, 160c.

The resource management system 110 may be a single server, multiple servers, a server farm, or any other such arrangement of computing devices to implement computing server-like functionality. In some embodiments, the resource management system 110 may track, manage, and maintain resources. The resources may, for example, be computer code, spreadsheet data, and/or database information and may include image, text, audio and/or video files. Additionally or alternatively, the resources may be computing resources, such as memory or processor cycles. Additionally or alternatively, the resources may be digital goods, such as digital media resources; fonts, logos, photos and graphics; digital subscriptions; online advertisements; internet coupons; electronic tickets; electronic documentation; downloadable software and/or mobile apps; cloud-based applications and online games; virtual goods used within the virtual economies of online games and communities; workbooks; worksheets; planners; e-learning (online courses); webinars, video tutorials; blog posts; cards; patterns; website themes; and/or templates. Examples of digital media resources include e-books, downloadable music, internet radio, internet television and/or streaming media. The resources may be a specific type of digital goods known as digital assets, and may include photography, logos, illustrations, animations, audiovisual media, presentations, spreadsheets, digital paintings, word documents, electronic mails, websites, and a multitude of other digital formats and their respective metadata. Digital assets may be subject to digital rights management (DRM) and/or digital asset management (DAM). By way of further example, the resources may be database resources, and may represent stored value, such as financial instruments, including fiat currency and cryptocurrency. In at least some implementations, the resources may be or include digital goods which are exchange mediums. For example, the digital goods may be or represent monetary instruments.

In some embodiments, the resource management system 110 may track, manage, and maintain owned resources belonging to respective entities. The resources may be represented in a database, and the database may be provided in secure storage(s). The secure storage(s) may be provided internally within the resource management systems 110 or externally. The secure storage(s) may, for example, be provided remotely from the resource management system 110. For example, the secure storage(s) may include one or more data centers. The data centers may, for example, store data with bank-grade security.

In some embodiments, the resource management system 110 may include records for a plurality of resource accounts and at least some of the records may define a quantity of resources. A client entity may be associated with one or more accounts storing or otherwise reflecting owned resources, i.e., an owned resource account. The records may reflect a quantity of stored resources that are associated with the client entity. Such resources may include owned resources. The amount of resources associated with the client entity may be reflected by a resource definition defined in an associated resource record. The resource definition may be or include a balance defined in an associated record; for example a bank balance.

As shown, the resource management system 110 may communicate with one or more transfer rail servers 120a, 120b. The one or more transfer rail servers 120a, 120b are computing systems that facilitate electronic funds transfer and may, in at least some embodiments, be referred to as payment rail servers. By way of example, the transfer rail servers 120a, 120b may be each a Visa™, Mastercard™, or American Express™ server. The transfer rail servers 120a, 120b may be each associated with a particular brand of value transfer cards. More particularly, each of the transfer rail servers 120a, 120b may facilitate payment processing for a particular brand of value transfer card, such as a particular brand of credit and/or charge card. By way of example, in some embodiments, the transfer rail server 120a may only process Visa transactions and the transfer rail server 120b may only process Mastercard transactions, etc. While two transfer rail servers 120a, 120b are illustrated in FIG. 1, the number of transfer rail servers 120a, 120b in communication with the resource management system 110 may be much greater. The transfer rail servers 120a, 120b may also, in at least some embodiments, be referred to as credit card network servers.

The resource management system 110 may be, for example, a computer system associated with a financial institution, such as a bank, that issued one or more value transfer cards. Put differently, the resource management system 110 may be associated with an issuer of one or more value transfer cards. For example, the resource management system 110 may be operated or managed by the issuer of one or more value transfer cards.

A value transfer card may be or include a credit card or charge card. The value transfer card may have certain associated data. For example, the value transfer card may be associated with a primary account number (PAN), a verification number such as a credit card verification (CCV) number and/or an expiry date. The value transfer card may be used by one or more of the transfer initiation systems 124a, 124b for processing a transfer of value from a cardholder to an entity associated with such systems.

The transfer initiation systems 124a, 124b may be or include, for example, electronic commerce (i.e., e-commerce) systems. An e-commerce system may be, for example, a server associated with one or more merchants that sells or facilitates the sale of goods and/or services online. An e-commerce server may, for example, process order data, including facilitating associated transfer card processing, for product purchase orders that are placed using user computing devices, which, as noted include gaming devices 160a, 160b, 160c, and client device 150. While two transfer initiation systems 124a, 124b are illustrated in FIG. 1, the number of transfer initiation systems 124a, 124b having a stored representation of the value transfer card may be much greater.

In order to process a transfer of value using a value transfer card, one or more of the transfer initiation systems 124a, 124b may communicate with the appropriate transfer rail server 120a, 120b. For example, a transfer initiation system 124a, 124b may send, to a transfer rail server 120a, 120b, a transfer request. The transfer request may specify, for example, an amount of value associated with the request. The transfer request may also be associated with one or more credentials associated with a value transfer card. The credentials may include, for example, the PAN, expiry date and/or verification number for the value transfer card.

The transfer request may include additional metadata. The metadata may include a merchant identifier such as an MID. The metadata may also include an indication that the transfer request is associated with an in-application transfer, and may further include an indication of a type of application (e.g., a gaming application) associated with the transfer.

The metadata may also include a device token, which may also be described as a push token. The device token may be unique to a particular user computing device and/or to the combination of a particular user computing device and a particular application operating on the particular computing device. The device token represents an address for the particular user computing device and/or the device/application combination. The particular user computing device and/or the device/application combination may be associated with the first transfer.

After the transfer rail server 120a, 120b receives the transfer request, it may communicate with an issuer computing system of an issuing entity, such as the resource management system 110, to request approval of the transfer request. The request for approval may include, for example, information included in or obtained from the transfer request, such as the amount of the transfer request. The request for approval may include, for example, the PAN, expiry date and/or verification number for the value transfer card. The request for approval may also include the associated MID, an indication that the transfer request is associated with an in-application transfer, an indication of a type of application (e.g., a gaming application) associated with the transfer, and/or the associated device token.

The transfer rail server 120a, 120b may then receives a response to the request for approval (e.g., either an indication of approval or an indication of denial) and may send a corresponding message to the appropriate transfer initiation system 124a, 124b.

In some embodiments, gaming devices 160a, 160b, and 160c are computing systems which may be or may include a gaming platform, such as, for example, a gaming console. A gaming console is a computing system designed for playing video games. Examples of gaming consoles include Sony PlayStation™ 5, Sony PlayStation™ VR, Microsoft Xbox™, and Nintendo Switch™, for example. A gaming console may use an operating system, such as Orbis™ OS, FreeBSD™, Nintendo Switch™ system software, Nintendo 3DS™, nOS™, Xbox One™, Xbox™ system software, or the like. A particular operating system operating on a particular gaming console may be associated with a device token. While first, second and third gaming devices are illustrated in FIG. 1, the number of gaming devices 160a, 160b, 160c in communication with the resource management system 110 may be much greater.

In some embodiments, gaming devices 160a, 160b, and 160c may each be associated with a merchant associated with a transfer initiation system 124a, 124b and having an MID.

Additionally or alternatively, in some embodiments, gaming devices 160a, 160b, and 160c and client device 150 may be or may include a personal computer (PC), a web browser, or a smart phone operating system. In such embodiments, one or more PC game applications, web game applications, and/or mobile game applications may operate on gaming devices 160a, 160b, and 160c, and/or client device 150. In such embodiments, the one or more PC game applications, web game applications, and/or mobile game applications may each be associated with a merchant associated with a transfer initiation system 124a, 124b and having a MID.

While playing a game using a gaming device 160a, 160b, 160c or the client device 150, a user may be provided with the opportunity to engage in a microtransaction, which may also be described as an in-game purchase. Microtransactions generally involve the acquisition of a game-related product or service and can only be implemented during active game play. Microtransactions may involve the acquisition of additional “lives” (in order to extend the game), the acquisition of in-game currencies, the acquisition of in-game products, such as clothing for characters in the game, and the acquisition of “loot boxes”, which are consumable virtual items which can be redeemed to receive a randomized selection of further virtual items for use in the game.

To facilitate the processing of microtransactions, a user computing device (i.e., one of the gaming devices 160a, 160b, 160c, and the client device 150) may store transfer card data associated with a value transfer card, such as the value transfer card number, an associated (PAN), a verification number such as a credit card verification (CCV) number and/or an expiry date. In this way, a microtransaction may be offered, accepted and processed during game play without undue interruption to the game play (e.g., without necessitating a break in the game to locate and to enter required transfer card data). The stored transfer card data in connection with a particular transfer card may be referred to as a “card-on-file”.

There are a number of drawbacks to microtransactions, including inadvertent overspending during gameplay. In some users suffering from gambling issues, gambling behaviours may be facilitated by microtransactions, especially in connection with the acquisition of “loot boxes”. Microtransactions can present a particular risk to child users, who may be unaware that their actions during game play will result in real-world charges to a parent's account. Microtransactions have been alleged to promote gambling behaviours at a young age.

During game play, a microtransaction opportunity may be provided to a user computing device (i.e., one of the gaming devices 160a, 160b, 160c, and the client device 150) via software operating on the user computing device. Acceptance of the microtransaction opportunity may then be indicated by a player (e.g., by the pressing of a virtual button within the game).

In response to receiving the indication of acceptance, the user computing device may send a message to an appropriate transfer initiation system 124a, 124b, to initiate a transaction with the merchant associated with the game and/or the gaming platform. The transaction may be processed using the card-on-file associated with the user computing device.

The client device 150 is a computing device. The client device may be associated with a client entity having resources associated with the resource management system 110. For example, the resource management system may be a financial institution server and the client entity may be a customer of a financial institution operating the financial institution server. Additionally or alternately, the client device may operate one or more PC game applications, web game applications, and/or mobile game applications. In such embodiments, the one or more PC game applications, web game applications, and/or mobile game applications may each be associated with a merchant associated with a transfer initiation system 124a, 124b and having a MID.

In some embodiments, the client device 150 may, as illustrated, be a personal computer such as a smart phone. However, the client device 150 may be a computing device of another type such as a laptop computer, a desktop computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments. In some embodiments, the client device 150 may include a smart card, chip card, integrated circuit card (ICC), and/or other card having an embedded integrated circuit.

As noted, the resource management system 110 may be an issuer computing system of an issuing entity. The resource management system 110 may communicate with a client device 150 via the network 130 in order to allow the client device 150 to be used in managing the value transfer card. In particular, the resource management system 110 and the client device 150 may cooperate to provide a card management user interface on an output device, such as a display, of the client device 150. A user may interact with the card management user interface in order to input instructions to the client device 150. At least some such instructions may cause the client device 150 to send a management request or command to the resource management system 110.

Other management features and functions may also be provided by the management user interface.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, or the like. Additionally or alternatively, the network 130 may be or may include one or more payment networks. The network 130 may, in some embodiments, include a plurality of distinct networks. For example, communications between certain of the computer systems may be over a private network whereas communications between other of the computer systems may be over a public network, such as the Internet.

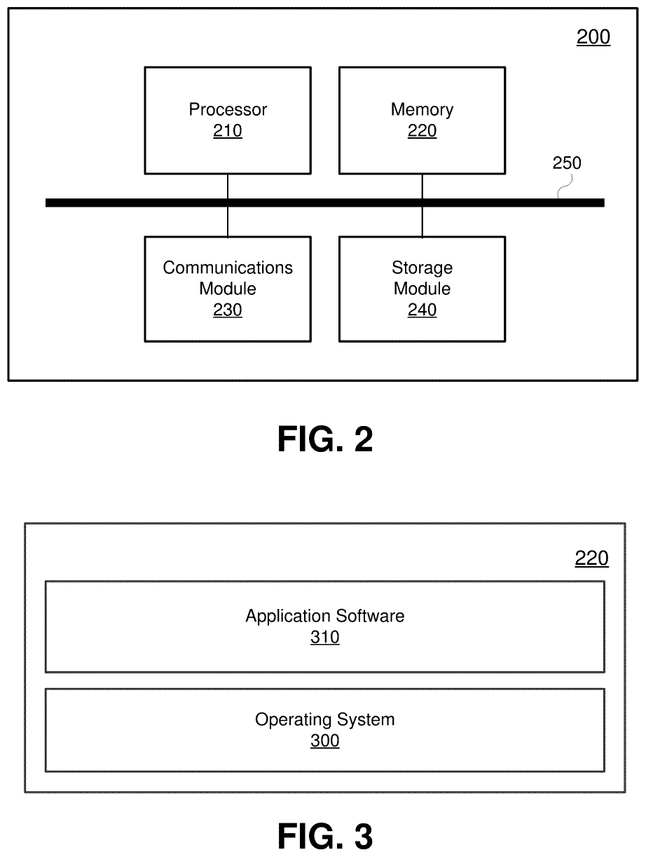

Referring now to FIG. 2, a high-level operation diagram of an example computing device 200 will now be described. The example computing device 200 may be exemplary of the resource management system 110, client device 150, transfer initiation systems 124a, 124b, the gaming devices 160a, 160b, 160c and/or the transfer rail servers 120a, 120b.

The example computing device 200 includes a variety of modules. For example, as illustrated, the example computing device 200 may include a processor 210, a memory 220, a communications module 230, and/or a storage module 240. As illustrated, the foregoing example modules of the example computing device 200 are in communication over a bus 250.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computing device 200.

The communications module 230 allows the example computing device 200 to communicate with other computing devices and/or various communications networks. For example, the communications module 230 may allow the example computing device 200 to send or receive communications signals. Communications signals may be sent or received according to one or more protocols or according to one or more standards. For example, the communications module 230 may allow the example computing device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 230 may allow the example computing device 200 to communicate using near-field communication (NFC), via Wi-Fi™, using Bluetooth™ or via some combination of one or more networks or protocols. In some embodiments, all or a portion of the communications module 230 may be integrated into a component of the example computing device 200. For example, the communications module may be integrated into a communications chipset.

The storage module 240 allows the example computing device 200 to store and retrieve data. In some embodiments, the storage module 240 may be formed as a part of the memory 220 and/or may be used to access all or a portion of the memory 220. Additionally or alternatively, the storage module 240 may be used to store and retrieve data from persisted storage other than the persisted storage (if any) accessible via the memory 220. In some embodiments, the storage module 240 may be used to store and retrieve data in a database. A database may be stored in persisted storage. Additionally or alternatively, the storage module 240 may access data stored remotely such as, for example, as may be accessed using a local area network (LAN), wide area network (WAN), personal area network (PAN), and/or a storage area network (SAN). In some embodiments, the storage module 240 may access data stored remotely using the communications module 230. In some embodiments, the storage module 240 may be omitted and its function may be performed by the memory 220 and/or by the processor 210 in concert with the communications module 230 such as, for example, if data is stored remotely. The storage module may also be referred to as a data store.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

The computing device 200 will include other components apart from those illustrated in FIG. 2 and the specific component set may differ based on whether the computing device 200 is operating as a resource management system 110, a client device 150, a transfer initiation system 124a, 124b, a gaming device 160a, 160b, 160c, or a transfer rail server 120a, 120b. For example, the computing device 200 may include one or more input modules, which may be in communication with the processor 210 (e.g., over the bus 250). The input modules may take various forms including, for example, a mouse, a microphone, a camera, a touchscreen overlay, a button, a sensor, etc. By way of further example, the computing devices 200 may include one or more output modules, which may be in communication with the processor 210 (e.g., over the bus 250). The output modules include one or more display modules which may be of various types including, for example, liquid crystal displays (LCD), light emitting diode displays (LED), cathode ray tube (CRT) displays, etc. By way of further example, the output modules may include a speaker.

FIG. 3 depicts a simplified organization of software components stored in the memory 220 of the example computing device 200 (FIG. 2). As illustrated, these software components include an operating system 300 and an application 310.

The operating system 300 is software. The operating system 300 allows the application 310 to access the processor 210 (FIG. 2), the memory 220, and the communications module 230 of the example computing device 200 (FIG. 2). The operating system 300 may be, for example, Google™, Android™, Apple iOS™, UNIX™, Linux™, Microsoft Windows™, Apple OSX™, Orbis™ OS, FreeBSD™ 9, Nintendo Switch™ system software, Nintendo 3DS™ system software, nOS™, Xbox One™, Xbox™ system software, or the like.

The application 310 adapts the example computing device 200, in combination with the operating system 300, to operate as a device performing a particular function. For example, the application 310 may cooperate with the operating system 300 to adapt a suitable embodiment of the example computing device 200 to operate as the resource management system 110, client device 150, transfer initiation systems 124a, 124b, or the transfer rail servers 120a, 120b.

While a single application 310 is illustrated in FIG. 3, in operation the memory 220 may include more than one application 310 and different applications 310 may perform different operations.

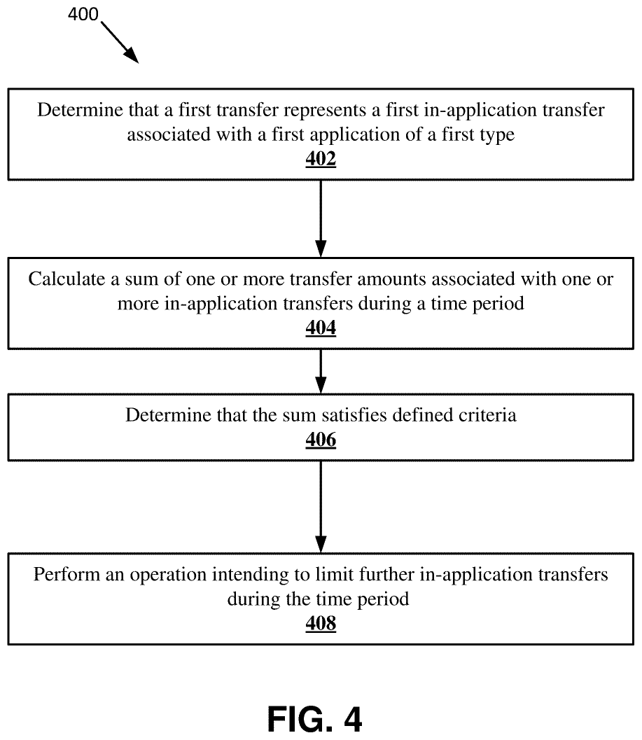

The operation of the resource management system 110 (FIG. 1) will now be described with reference to the flowchart of FIG. 4 which illustrates a method 400 for performing an operation intending to limit further in-application transfers, in accordance with embodiments of the present disclosure. Operations 402 and onward are performed by one or more processors of a computing device, such as for example the processor 210 of a suitably configured instance of the example computing device 200, executing software such as, for example, a suitable instance of the application 310.

At the operation 402, the resource management system 110 determines, based on a first transfer identifier associated with a first transfer having a first transfer amount, that the first transfer represents a first in-application transfer associated with a first application of a first type, the first transfer being associated with a first account.

The first transfer identifier may be or may include an MID, and as such, may identify the merchant associated with the first transfer. The MID may indicate, for example, that the merchant is Nintendo™ eShop, Microsoft™ Store, Sony PlayStation™ Store, Apple™ Services, Google Play™ Store, etc. The first transfer identifier may further include an indication of the nature and/or type of the transfer. For example, the first transfer identifier may indicate that the transfer is an in-application transfer and that a particular type of application (e.g., a gaming application) associated with the transfer.

At the operation 404, the resource management system 110 calculates a sum of one or more transfer amounts associated with one or more in-application transfers during a time period, the one or more in-application transfers being associated with the first account and including the first transfer, the one or more in-application transfers being associated with one or more applications of the first type.

As noted, in some embodiments, the one or more applications of the first type may be one or more gaming applications, and the one or more in-application transfers may be microtransactions. The time period may be defined, for example, as one hour, one day, one week, one month, etc.

In some embodiments, the one or more in-application transfers are further associated with a first transfer card associated with the first account. In other words, in some embodiments, the calculated sum includes transfer amounts in connection with a single transfer card associated with the first account.

At the operation 406, the system determines, based on a threshold defined for the time period, that the sum satisfies defined criteria.

In some embodiments, the threshold is a defined amount and the defined criteria are satisfied when the calculated sum exceeds a certain percentage of the defined amount.

For example, in some embodiments, the threshold may be defined as $20.00, $50.00, $100.00, etc. The threshold may be previously defined by the user. In some implementations, the certain percentage may be 100%, i.e., the defined criteria may be satisfied when the calculated sum exceeds 100% of the threshold. In some implementations, the certain percentage may be less than 100%, for example, 80% or 90%. In some embodiments, the defined criteria may be defined by a user.

At the operation 406, in response to determining that the sum satisfies the defined criteria, the system performs an operation intending to limit further in-application transfers associated with the first account during the time period, the in-application transfers being associated with the one or more applications of the first type.

In some embodiments, performing the operation intending to limit further in-application transfers may include a restriction in connection with the first account to prevent further related in-application transfers until the expiry of the time period. For example in some embodiments, performing the operation intending to limit further in-application transfers includes restricting, for a remainder of the time period, approval of subsequent transfer requests associated with the first account in connection with an in-application transfer associated with an application of the first type.

Additionally or alternatively, in some embodiments, performing the operation intending to limit further in-application transfers may include providing a notification. In some embodiments, performing the operation intending to limit further in-application transfers may include restricting, for a remainder of the time period, approval of subsequent transfer requests in connection with the first account and associated with an in-application transfer in connection with an application of a first type.

In some embodiments, prior to calculating the sum of one or more transfers amounts, the system may determine, based on a second transfer identifier associated with a second transfer having a second transfer amount, that the second transfer represents a second in-application transfer in connection with a second application of the first type, the second transfer being associated with the first account. Accordingly, in such embodiments, the one or more transfer amounts may include the second transfer amount.

In some embodiments including the second transfer, the first transfer is associated with a first transfer card associated with the first account, and the second transfer is associated with a second transfer card associated with the first account. In other words, in some embodiments, the calculated sum includes transfer amounts associated with more than one transfer card associated with the first account.

In some embodiments including the second transfer, the first and second transfer and each of the one or more transfer amounts are associated with the first transfer card.

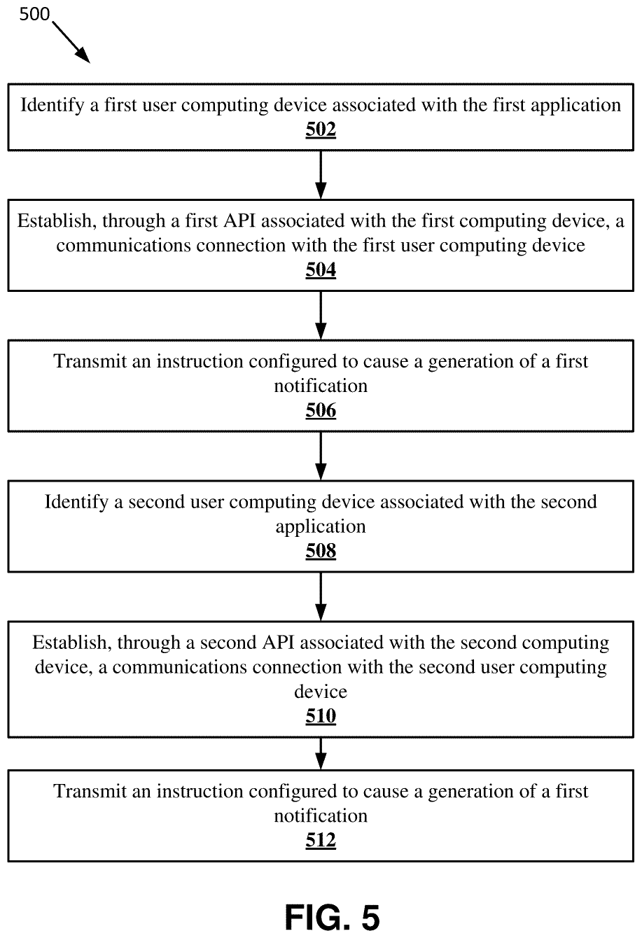

Reference is now made to FIG. 5, which illustrates a method 500 for transmitting an instruction configured to cause a generation of a first notification, in accordance with embodiments of the present disclosure. Operations 502 and onward are performed by one or more processors of a computing device, such as for example the processor 210 of a suitably configured instance of the example computing device 200, executing software such as, for example, a suitable instance of the application 310.

At the operation 502, the system identifies a first user computing device associated with the first application.

In some embodiments, as noted, the transfer request includes metadata comprising a device token. The device token may be unique to a particular user computing device and/or to the combination of a particular user computing device and a particular application operating on the particular computing device. The device token represents an address for the particular user computing device and/or the device/application combination. The particular user computing device and/or the device/application combination may be associated with the first transfer. The system may identify the first user computing device associated with the first application using the device token. The system may further identify the first application using the device token.

In some implementations, the first computing device may be a Nintendo Switch device and the first application may be an implementation of Nintendo Switch software operating on the Nintendo Switch device. In some implementations, for example, the first computing device may be a Microsoft Xbox™, device and the first computing application may be an implementation of Xbox™, system software operating on the Microsoft Xbox™, device. In some implementations, for example, the first computing device may be a PlayStation™, device and the first computing application may be an implementation of a PlayStation™, OS software operating on the PlayStation™, device. In some implementations, the first computing device may be a smart phone and the first computing application may be a mobile gaming application operating on the smart phone. In some implementations, the first computing device may be a desktop computer and the first computing application may be a PC gaming application operating on the desktop computer.

At the operation 504, the system establishes, via the communication module and through a first API associated with the first application, a communications connection with the first user computing device.

At the operation 506, the system transmits, via the communications module, an instruction configured to cause a generation, by the first computing device, of a first notification.

The first notification may be associated with the threshold and the defined criteria. For example, in some embodiments, as noted, the defined criteria are satisfied when the calculated sum exceeds a certain percentage of the threshold amount. In implementations where the percentage is less than 100%, the first notification may indicate that a threshold amount is being approached. In implementations where the percentage is 100%, the first notification may indicate that the threshold amount has been exceeded.

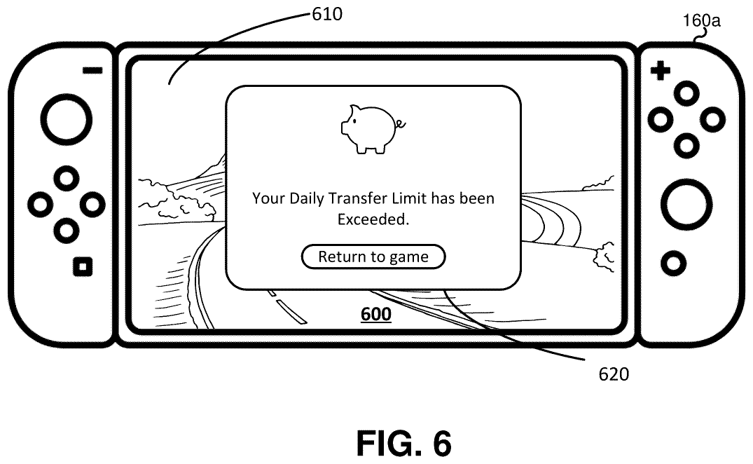

Reference is now made to FIG. 6 which shows the front of a first example gaming device 160a of FIG. 1. The first example gaming device 160a is a personal computing device operating as a gaming console.

As illustrated, the front of the first example gaming device 160a includes a display 610. The display 610 is a module of the first example gaming device 160a. The display 610 is for presenting graphics. As illustrated by FIG. 6, the display 610 of the first example gaming device 160a may present the first example user interface 600, which displays the first notification 620. The first notification 620 recites, “Your Daily Transfer Limit has been Exceeded”.

In this way, a first notification may be generated by the first computing device. In this way, a user of the first computing device may be notified that the defined criteria have been satisfied.

In some embodiments, the execution of the method 500 may cease after the operation 506. For example, in some implementations, a user may have a single “card-on-file” stored in connection with a single gaming device. As a further example, in some implementations, a user may have configured notification settings such that only a first notification is generated.

Returning again to FIG. 5, after the operation 506, the operation 508 is next.

At the operation 508, the system identifies a second user computing device associated with the second application.

In some embodiments, as noted, a transfer request includes metadata comprising a device token. The device token is unique to a particular user computing device and a particular application. The device token represents an address for the particular user computing device and the particular application. The particular gaming device and the particular application may be associated with the second transfer. The system may identify the second user computing device associated with the second application using the device token. The system may further identify the second application using the device token.

In some implementations, the second computing device may be a Nintendo Switch™ device and the first application may be an implementation of Nintendo Switch™ software operating on the Nintendo Switch™ device. In some implementations, for example, the second computing device may be a Microsoft Xbox™ device and the second computing application may be an implementation of Xbox™ system software operating on the Microsoft Xbox™ device. In some implementations, for example, the second computing device may be a PlayStation™ device and the second computing application may be an implementation of a PlayStation™ OS software operating on the PlayStation™ device. In some implementations, the first computing device may be a Nintendo Switch™ device and the first application may be an implementation of Nintendo Switch™ software operating on the Nintendo Switch™ device. In some implementations, for example, the first computing device may be a Microsoft Xbox™ device and the first computing application may be an implementation of Xbox™ system software operating on the Microsoft Xbox™ device. In some implementations, for example, the first computing device may be a PlayStation™ device and the first computing application may be an implementation of a PlayStation™ OS software operating on the PlayStation™ device. In some implementations, the first computing device may be a smart phone and the first computing application may be a mobile gaming application operating on the smart phone. In some implementations, the first computing device may be a desktop computer and the first computing application may be a PC gaming application operating on the desktop computer.

At the operation 510, the system establishes, via the communication module and through a second API associated with the second application, a communications connection with the second user computing device.

At the operation 512, the system transmits, via the communications module, an instruction configured to cause a generation, by the second computing device, of a second notification.

The second notification may be associated with the threshold and the defined criteria. For example, in some embodiments, as noted, the defined criteria are satisfied when the calculated sum exceeds a certain percentage of the threshold amount. In implementations where the percentage is less than 100%, the second notification may indicate that a threshold amount is being approached. In implementations where the percentage is 100%, the second notification may indicate that the threshold amount has been exceeded.

In this way, the number of users of the account and/or the “card-on-file” is maximized. In this way, the likelihood of the account owner and/or the “card-on-file” owner receiving the notification is maximized.

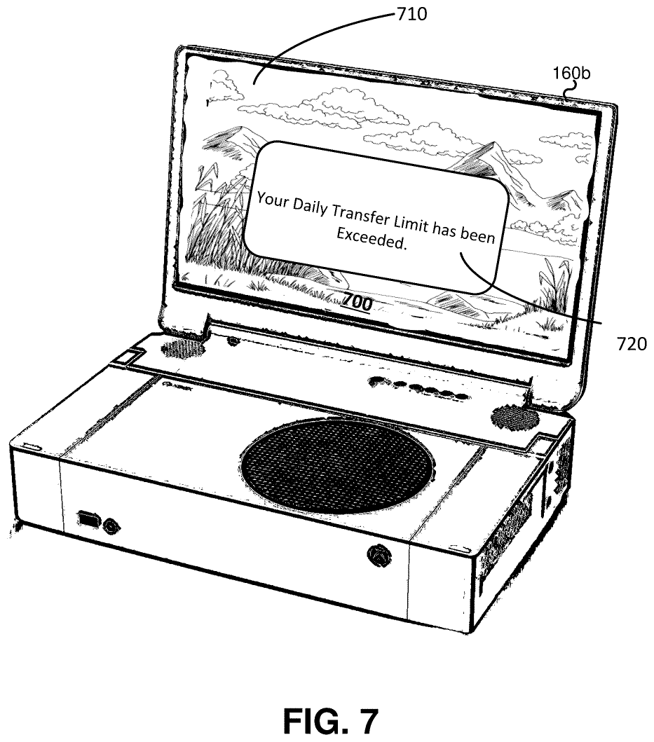

Reference is now made to FIG. 7, which shows the front of a second example gaming device 160c of FIG. 1. The second example gaming device 160b is a personal computing device operating as a gaming console.

As illustrated, the front of the second example gaming device 160b includes a display 710. The display 710 is a module of the second example gaming device 160b. The display 710 is for presenting graphics. As illustrated by FIG. 7, the display 710 of the second example gaming device 160b may present the second example user interface 700, which displays the second notification 720. The second notification 720 recites, “Your Daily Transfer Limit has been Exceeded. No more in-game purchases may be made today.”

In this way, a second notification may be generated by the second computing device. In this way, a user of the second computing device may be notified that the defined criteria have been satisfied.

Returning again to FIG. 4, in some embodiments, prior to the operation 408, the system may determine that a third transfer associated with the first account and occurring outside of the time period represents a third in-application transfer associated with a third application of the first type. In other words, in some embodiments, the system may determine that an in-application transfer associated with the first account has occurred outside the time period in connection with a third application.

In such embodiments, performing the operation intending to limit further in-application transfers may include transmitting an instruction configured to cause a generation, by a third user computing device, of a third notification. For example, in some embodiments, performing the operation intending to limit further in-application transfers may include identifying a third user computing device associated with a third application, establishing, via the communications module and through a third API associated with the third computing device, a communications connection with the third computing device, and transmitting, via the third communications module, an instruction configured to cause a generation, by the third computing device, of a third notification.

In this way, a user computing device associated with a prior transfer associated with the first account may be caused to generate a notification, even when the prior transfer occurred outside of the time period.

In some embodiments, performing an operation intending to limit further in-application transfers associated with the first account may include providing user interface data to a fourth user computing device associated with the first account. The user interface data may cause the fourth user computing device to display a user interface including a third notification.

In some embodiments, the fourth user computing device may be, for example, a computing device associated with in-applications transfers associated with one or more applications of the first type. Additionally or alternatively, in some embodiments, the third computing device may be, for example, a computing device operating an application (e.g., a banking application) for managing transfers associated with the first account.

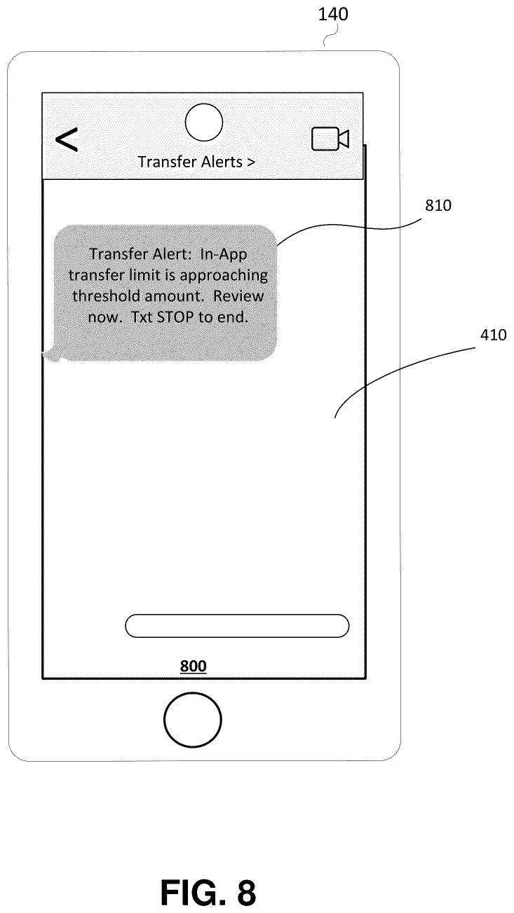

Reference is now made to FIG. 8, which illustrates a third example user interface 800 including a fourth notification 810, in accordance with embodiments of the present disclosure. As illustrated by FIG. 8, the display 410 of the client device 150 may present the third example user interface 800, which displays the fourth notification 810. The fourth notification 810 recites, “Transfer Alert: In-App transfer limit is approaching threshold amount. Review now. Txt STOP to end.”

In this way, the system may provide, to a fourth user computing device, user interface data to cause the fourth user computing device to display a user interface including a fourth notification. The fourth notification may be provided in response to determining that a calculated sum satisfies defined criteria.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

What is claimed is:

1. A computer system comprising:
a processor;
a communications module coupled to the processor; and
a memory coupled to the processor and storing instructions that, when executed by the processor, cause the computer system to:
determine, based on a first transfer identifier associated with a first transfer having a first transfer amount, that the first transfer represents a first in-application transfer associated with a first application of a first type, the first transfer being associated with a first account;
calculate a sum of one or more transfer amounts associated with one or more in-application transfers during a time period, the one or more in-application transfers being associated with the first account and including the first transfer, the one or more in-application transfers being associated with one or more applications of the first type;
determine, based on a threshold defined for the time period, that the sum satisfies defined criteria; and
in response to determining that the sum satisfies the defined criteria, perform an operation intending to limit further in-application transfers associated with the first account during the time period, the in-application transfers being associated with the one or more applications of the first type.

2. The computer system of claim 1, wherein performing the operation causes the computer system to:
identify a first user computing device associated with the first application;
establish, via the communications module and through a first application programming interface (API) associated with the first user computing device, a communications connection with the first user computing device; and
transmit, via the communications module, an instruction configured to cause a generation, by the first user computing device, of a first notification.

3. The computer system of claim 1, wherein performing the operation causes the computer system to:
restrict, for a remainder of the time period, approval of subsequent transfer requests in connection with an in-application transfer associated with an application of a first type, wherein the subsequent transfer requests are associated with the first account.

4. The computer system of claim 1, wherein the one or more in-application transfers are further associated with a first transfer card associated with the first account.

5. The computer system of claim 1, wherein prior to calculating the sum, the computer system is further caused to:
determine, based on a second transfer identifier associated with a second transfer having a second transfer amount, that the second transfer represents a second in-application transfer in connection with a second application of the first type, the second transfer being associated with the first account,
wherein the one or more transfer amounts further include the second transfer amount.

6. The computer system of claim 5, wherein performing the operation causes the computer system to:
identify a first user computing device associated with the first application;
establish, via the communications module and through a first API associated with the first user computing device, a communications connection with the first user computing device;
transmit, via the communications module, an instruction configured to cause a generation, by the first user computing device, of a first notification;
identify a second user computing device associated with the second application;
establish, via the communications module and through a second API associated with the second user computing device, a communications connection with the second user computing device; and
transmit, via the communications module, an instruction configured to cause a generation, by the second user computing device, of a second notification.

7. The computer system of claim 5, wherein prior to performing the operation intended to limit further in-application transfers, the computer system is further caused to:
determine that a third transfer represents a third in-application transfer associated with a third application of the first type, the third transfer being associated with the first account and occurring outside of the time period, and
wherein performing the operation causes the computer system to:
identify a third user computing device associated with the third application;
establish, via the communications module and through a third API associated with the third user computing device, a communications connection with the third user computing device; and
transmit, via the communications module, an instruction configured to cause a generation, by the third user computing device, of a third notification.

8. The computer system of claim 6, wherein performing the operation further causes the computer system to:
provide user interface data to a fourth user computing device associated with the first account, the user interface data causing the fourth user computing device to display a user interface including a fourth notification.

9. The computer system of claim 5, wherein the first transfer is associated with a first transfer card associated with the first account, and wherein the second transfer is associated with a second transfer card associated with the first account.

10. The computer system of claim 1, wherein the threshold is a defined amount and wherein the defined criteria are satisfied when the calculated sum exceeds a certain percentage of the defined amount.

11. A computer-implemented method comprising:
determining, based on a first transfer identifier associated with a first transfer having a first transfer amount, that the first transfer represents a first in-application transfer associated with a first application of a first type, the first transfer being associated with a first account;
calculating a sum of one or more transfer amounts associated with one or more in-application transfers during a time period, the one or more in-application transfers being associated with the first account and including the first transfer, the one or more in-application transfers being associated with one or more applications of the first type;
determining, based on a threshold defined for the time period, that the sum satisfies defined criteria; and
in response to determining that the sum satisfies the defined criteria, performing an operation intending to limit further in-application transfers associated with the first account during the time period, the in-application transfers being associated with the one or more applications of the first type.

12. The method of claim 11, wherein performing the operation comprises:
identifying a first user computing device associated with the first application;
establishing, via a communications module and through a first application programming interface (API) associated with the first user computing device, a communications connection with the first user computing device; and
transmitting, via the communications module, an instruction configured to cause a generation, by the first user computing device, of a first notification.

13. The method of claim 11, wherein performing the operation comprises:
restricting, for a remainder of the time period, approval of subsequent transfer requests in connection with an in-application transfer associated with an application of a first type, wherein the subsequent transfer requests are associated with the first account.

14. The method of claim 11, wherein the one or more in-application transfers are further associated with a first transfer card associated with the first account.

15. The method of claim 11, wherein prior to calculating the sum, the method further comprises:
determining, based on a second transfer identifier associated with a second transfer having a second transfer amount, that the second transfer represents a second in-application transfer in connection with a second application of the first type, the second transfer being associated with the first account,
wherein the one or more transfer amounts further include the second transfer amount.

16. The method of claim 15, wherein performing the operation comprises:
identifying a first user computing device associated with the first application;
establishing, via a communications module and through a first API associated with the first user computing device, a communications connection with the first user computing device;
transmitting, via the communications module, an instruction configured to cause a generation, by the first user computing device, of a first notification;
identifying a second user computing device associated with the second application;
establishing, via the communications module and through a second API associated with the second user computing device, a communications connection with the second user computing device; and
transmitting, via the communications module, an instruction configured to cause a generation, by the second user computing device, of a second notification.

17. The method of claim 15, wherein prior to performing the operation intended to limit further in-application transfers, the method further comprises:
determining that a third transfer represents a third in-application transfer associated with a third application of the first type, the third transfer being associated with the first account and occurring outside of the time period, and
wherein performing the operation comprises:
identifying a third user computing device associated with the third application;
establishing, via a communications module and through a third API associated with the third user computing device, a communications connection with the third user computing device; and
transmitting, via the communications module, an instruction configured to cause a generation, by the third user computing device, of a third notification.

18. The method of claim 15, wherein performing the operation further comprises:
providing user interface data to a fourth user computing device associated with the first account, the user interface data causing the fourth user computing device to display a user interface including a fourth notification.

19. The method of claim 16, wherein the first transfer is associated with a first transfer card associated with the first account, and wherein the second transfer is associated with a second transfer card associated with the first account.

20. A non-transitory computer-readable storage medium comprising processor-executable instructions which, when executed, configure a processor to:
determine, based on a first transfer identifier associated with a first transfer having a first transfer amount, that the first transfer represents a first in-application transfer associated with a first application of a first type, the first transfer being associated with a first account;
calculate a sum of one or more transfer amounts associated with one or more in-application transfers during a time period, the one or more in-application transfers being associated with the first account and including the first transfer amount, the one or more in-application transfers being associated with one or more applications of the first type; determine, based on a threshold defined for the time period, that the sum satisfies defined criteria; and
in response to determining that the sum satisfies the defined criteria, perform an operation intending to limit further in-application transfers associated with the first account during the time period, the in-application transfers being associated with the one or more applications of the first type.
